(19) United States
(12) Patent Application Publication
(10) Pub. No.: US 2009/0298327 A1
(43) Pub. Date: Dec. 3, 2009

(54) CONNECTING MODULE

(76) Inventors: Chien-Chun Wang, Taoyuan County (TW); Chih-Fan Wu, Taoyuan County (TW)

Correspondence Address: Chien-Hui Su, P. O. Box 70-121 Taichung, Taichung City, 40899, TW

(21) Appl. No.: 12/209,180

(22) Filed: Sep. 11, 2008

(30) Foreign Application Priority Data
May 30, 2008 (TW) 097209452
May 30, 2008 (TW) 097209632

(51) Int. Cl. H01R 31/08

(52) U.S. Cl. 439/507

(57) ABSTRACT

A connecting module includes a flat cable including a series of wires disposed therein and being laterally parallel to one another. Each wire has a bared end disposed on one end thereof. A circuit board is electrically connected to the flat cable. The circuit board includes a first conductive section and a second conductive section respectively disposed thereon. The first conductive section is electrically connected to the bared end of each of the series of wires. The first conductive section and the second conductive section are electrically connected to each other via a displacement circuit that is disposed in the circuit board such that correspondences between the first conductive section and the second conductive section are displaced for providing a function as jumper(s).

### BACKGROUND OF THE INVENTION

1. Field of the Invention

The present invention relates to a connecting module, and more particularly to a connecting module having a circuit board in which a displacement circuit is disposed for providing function as jumper(s).

2. Description of Related Art

As well known, connectors are used as a medium for relatively transmitting signal between/among electric equipments. A conventional connector has two joints disposed to two opposite ends thereof or has one end electrically connected to a circuit board and the other end having a joint mounted thereon relative to the operational condition. However, some conventional connectors need to have a structure to provide a function as jumper(s).

Conventional connecting devices usually include a flat cable electrically connected to a connector in which a series of lead pins is disposed. Each lead pin protrudes out of the connector to form a connecting end. However, the series of lead pins simply provides a function of transmitting signal without concerning the function as jumpers. Consequently, the some wires in the flat cable need to be displaced when the connecting device needs to use the function as jumpers for being suitable to different interfaces.

As a result, the previously displaced flat cable is only provided to connect unique electric equipment such that the user needs to prepare multiple connecting devices with different displaced flat cable for various electric equipments. Consequently, the use scope of the conventional connecting device is limited. In addition, the bad rate of manufacturing the conventional connecting device is raised. The conventional connecting device without jumper function needs to be advantageously altered.

The present invention has arisen to mitigate and/or obviate the disadvantages of the conventional connecting device that has no function concerning jumper.

### SUMMARY OF THE INVENTION

The main objective of the present invention is to provide an improved connecting module having a circuit board in which a displacement circuit is disposed for providing function as jumper(s).

To achieve the objective, the connecting module in accordance with the present invention comprises a flat cable including a series of wires disposed therein and being laterally parallel to one another. Each wire has a bared end disposed on one end thereof. A circuit board is electrically connected to the flat cable. The circuit board includes a first conductive section and a second conductive section respectively disposed thereon. The first conductive section is electrically connected to the bared end of each of the series of wires. The first conductive section and the second conductive section are electrically connected to each other via a displacement circuit that is disposed in the circuit board such that correspondences between the first conductive section and the second conductive section are displaced for providing a function as jumper(s). An insulator encloses the circuit board. The insulator is formed with a positioning portion for connecting with the circuit board, wherein the second conductive section extends through the positioning portion and is adapted to be connected to an extra electric interface.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a connecting module in accordance with the present invention;

FIG. 2 is an exploded perspective view of a connecting module in another direction for showing the bottoms of the elements;

FIG. 3 is a partially exploded perspective view of the connecting module in accordance with the present invention;

FIG. 4 is a perspective view of the connecting module in accordance with the present invention;

FIG. 5 is an exploded perspective view of a second embodiment of the connecting module in accordance with the present invention;

FIG. 6 is a perspective view of a second embodiment of the connecting module in accordance with the present invention;

FIG. 7 is an exploded perspective view of a third embodiment of the connecting module in accordance with the present invention;

FIG. 8 is an exploded perspective view of the third embodiment of the connecting module of the present invention for showing the bottom of the elements;

FIG. 9 is a perspective view of the third embodiment of the connecting module in accordance with the present invention;

FIG. 10 is an exploded perspective view of a fourth embodiment of the connecting module in accordance with the present invention;

FIG. 11 is an exploded perspective view of the fourth embodiment of the connecting module in another direction for showing the bottoms of elements;

FIG. 12 is a perspective view of the fourth embodiment of the connecting module in accordance with the present invention; and

FIG. 13 is a perspective view of a fifth embodiment of the connecting module in accordance with the present invention.

### DETAILED DESCRIPTION OF THE INVENTION

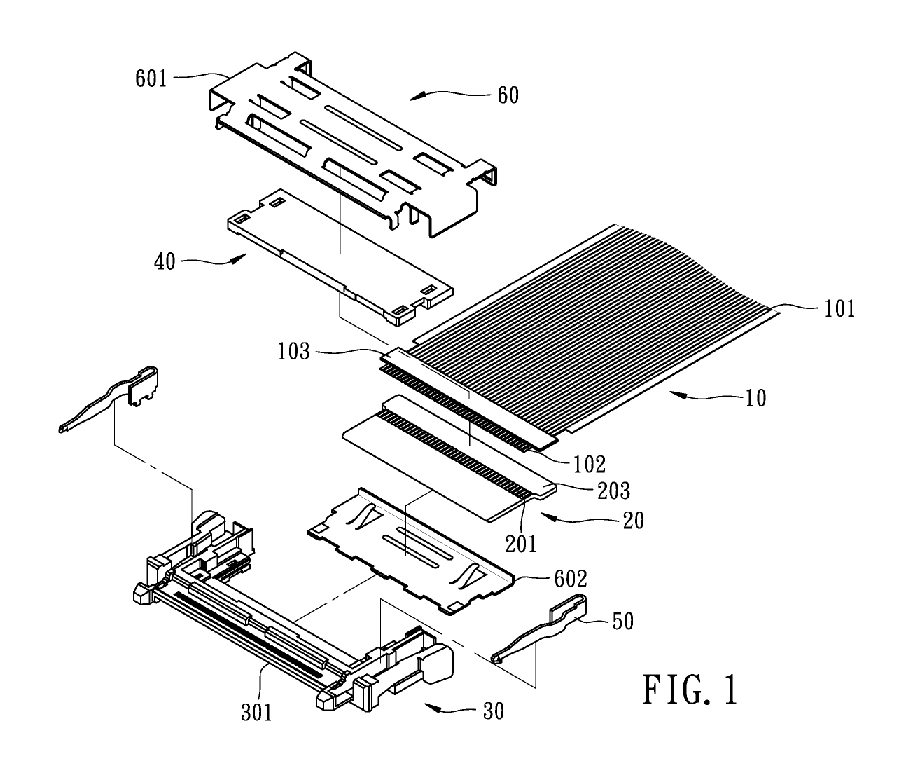

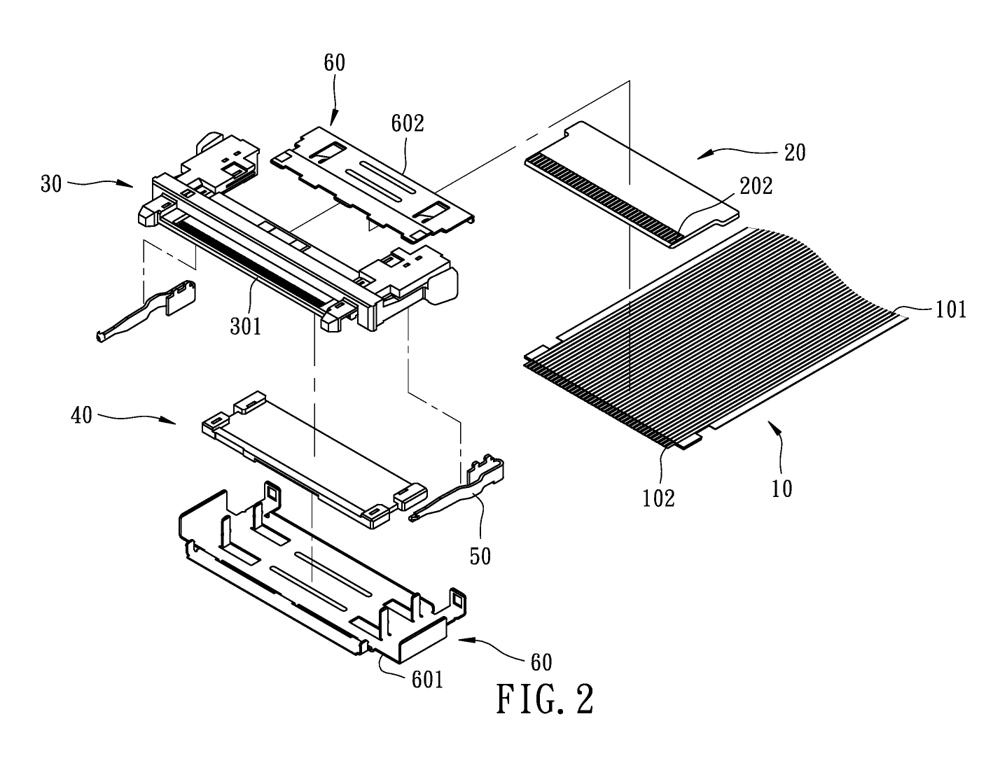

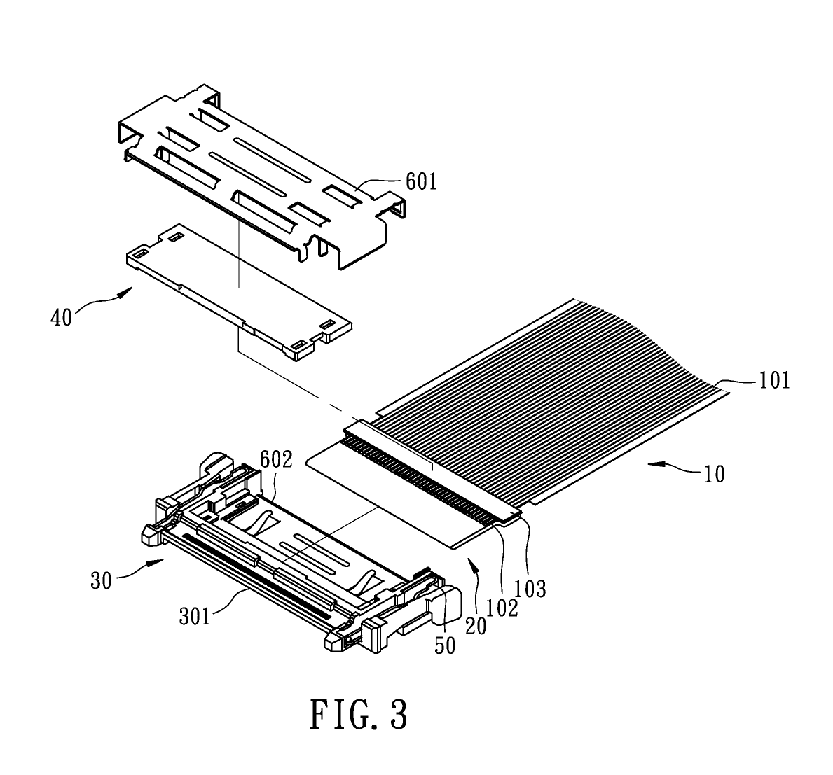

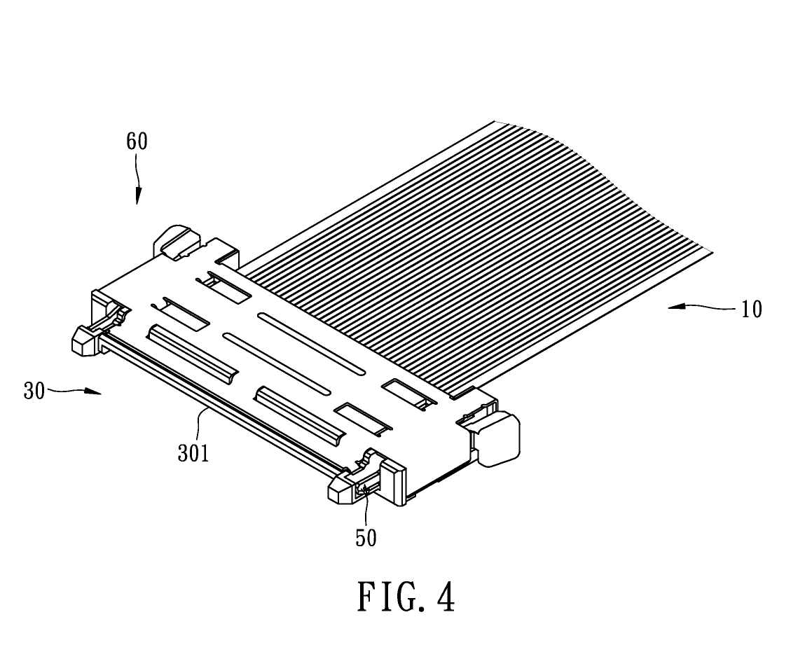

Referring to the drawings and initially to FIGS. 1-4, a connecting module in accordance with the present invention comprises flat cable (10), a circuit board (20) electrically connected to the flat cable (10) and an insulator (30) enclosing the circuit board (20).

The flat cable (10) includes a series of wires (101) disposed therein and being laterally parallel to one another. Each wire (101) has bared end (102) disposed on one end thereof. A plate (103) is attached to the flat cable (10) near the series of bared ends (102) for enhancing the structure of the flat cable (10). In the preferred embodiment of the present invention, the flat cable (10) is flexible.

The circuit board (20) is a printed circuit board (PCB) and has two opposite sides respectively having a first conductive section (201) and a second conductive section (202) disposed thereon. In the preferred embodiment of the present invention, the first conductive section (201) is used to connect to bared ends (102) of the flat cable (10). The first conductive section (201) and the second conductive section (202) are electrically connected to each other via a displacement circuit that is disposed in the circuit board (20). Consequently, the displacement circuit make the correspondences between the first conductive section (201) and the second conductive section (202) be displaced for providing a function as jumper(s). The circuit board (20) has a position plate (203) formed thereon and corresponding to the plate (103). The first conductive section (201) aligns with the series of bared ends (102) for easily soldering the first conductive section (201) with the series of bared ends (102) when the position plate (203) is aimed at the plate (103).

An insulator (30) is connected to the circuit board (20). The insulator (30) is formed with a positioning portion (301) for connecting with the circuit board (20). The second conductive section (202) extends through the positioning portion (301) and is adapted to be connected to an extra electric interface.

A positioning plate (40) is attached to the insulator (30) for holding the circuit board (20) in place. In the preferred embodiment of the present invention, the positioning plate (40) is made of plastic material for providing an insulating function.

Two fasteners (50) are respectively mounted to two opposite ends of the insulator (30) for holding the insulator (30) in place when the second conductive section (202) is electrically connected to the extra electric interface.

The housing (60) is mounted on the insulator (30). The housing (60) includes an upper shell (601) and a lower shell (602) abutting each other for defining a receiving space that is provided to receive the insulator (30) with the positioning plate (40) and the circuit board (20).

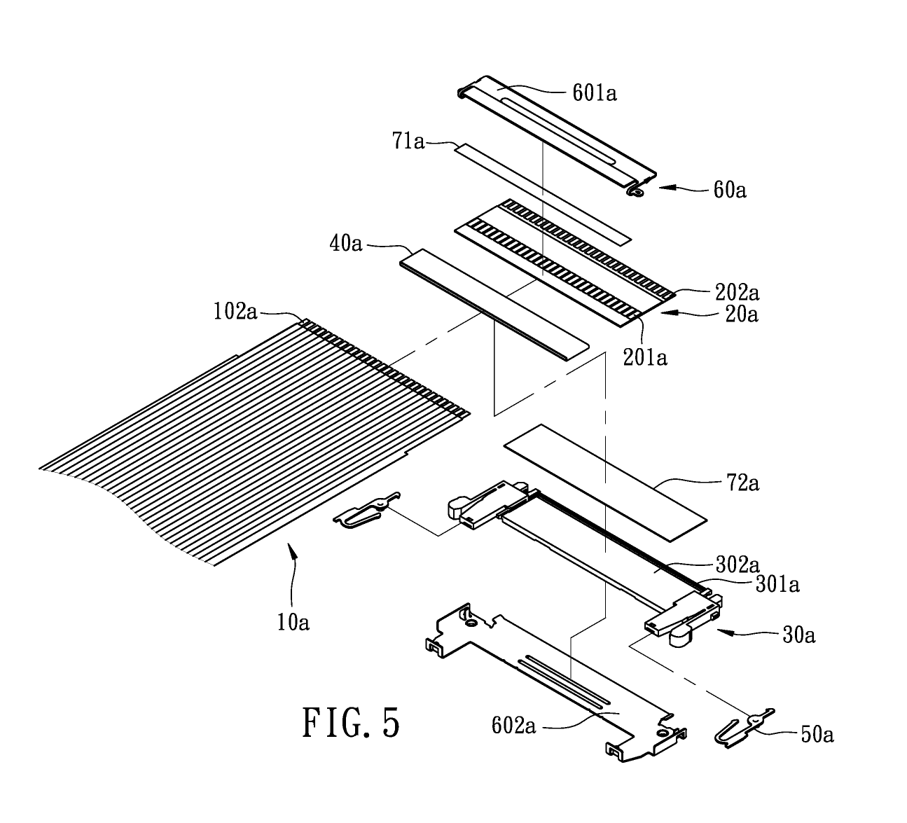

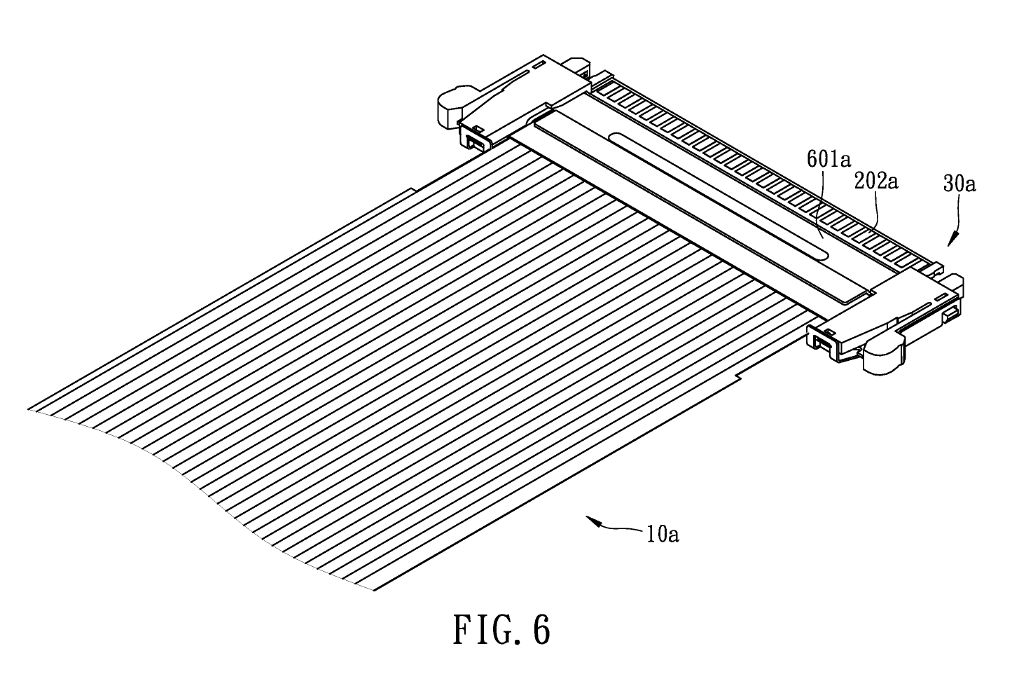

With reference to FIGS. 5 and 6 that show a second embodiment of the connecting module in accordance with the present invention, most of the structures of the second embodiment are similar to that of the first embodiment, hereinbefore. In this embodiment, the flat cable (10a) is flexible and has a series of bared end (102a) disposed on one end thereof.

When assembling, the series of bared ends (102a) is pseudo-positioned in the circuit board (20a) via a first double-sided adhering layer (71a). The series of bared ends (102a) is electrically connected with the first conductive section (201a) by solder after the series of bared ends (102a) being aligned with the first conductive section (201a). A loop (40a) encloses the circuit board (20a) with the soldered series of bared ends (102a) and the first conductive section (201a) for providing an insulating effect and enhancing the connection between the soldered series of bared ends (102a) and the first conductive section (201a). As shown in FIG. 5, in this embodiment, the second conductive section (202a) and first conductive section (201a) are disposed on the same side of the circuit board (20).

The insulator (30a) is formed with a positioning portion (301a) and a flat portion (302a), wherein the positioning portion (301a) is situated on a distal side of the flat portion (302a). A second double-sided adhering layer (72a) is sandwiched between the circuit board (20a) and the flat portion (302a) such that the circuit board (20a) is fixed on the flat portion (302a), wherein the second conductive section (202a) extends through the insulator (30a) via the positioning portion (301a) for electrically connected to an extra electric interface. The insulator (30a) has two opposite ends each having a fastener (50a) secured thereon for positioning the insulator (30a) when the second conductive section (202a) is electrically connected to the extra electric interface. A housing (60a) is provided to enclose the flat portion (302a) and the circuit board (20a). The housing (60a) has an upper shell (601a) and a lower shell (602a) connected to each other to define a space for receiving the flat portion (302a) and the circuit board (20a).

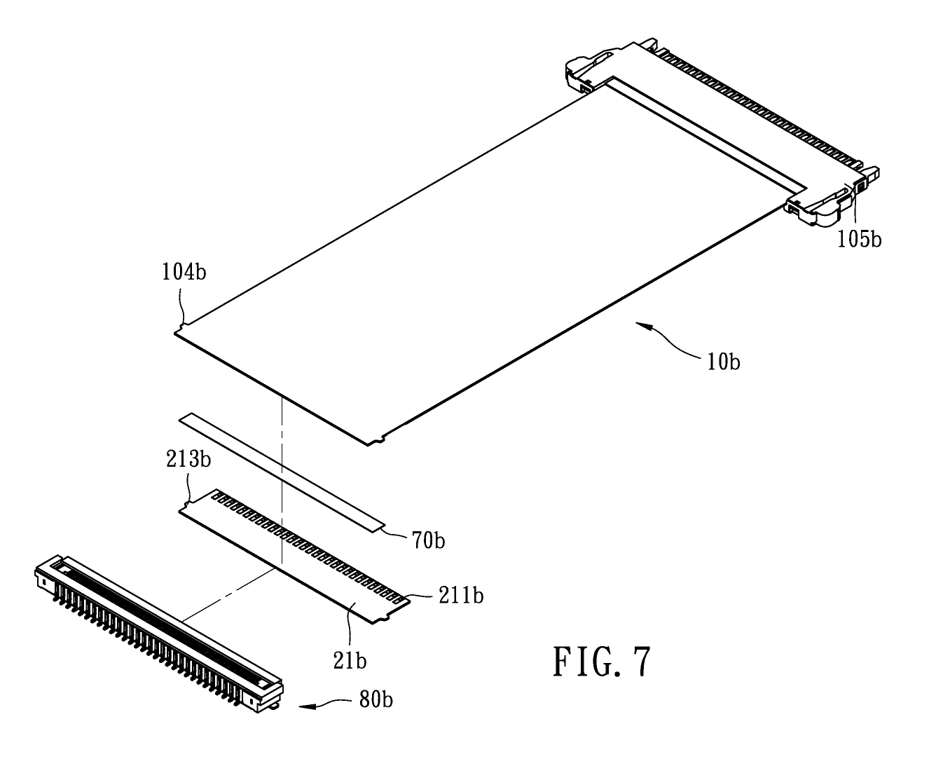

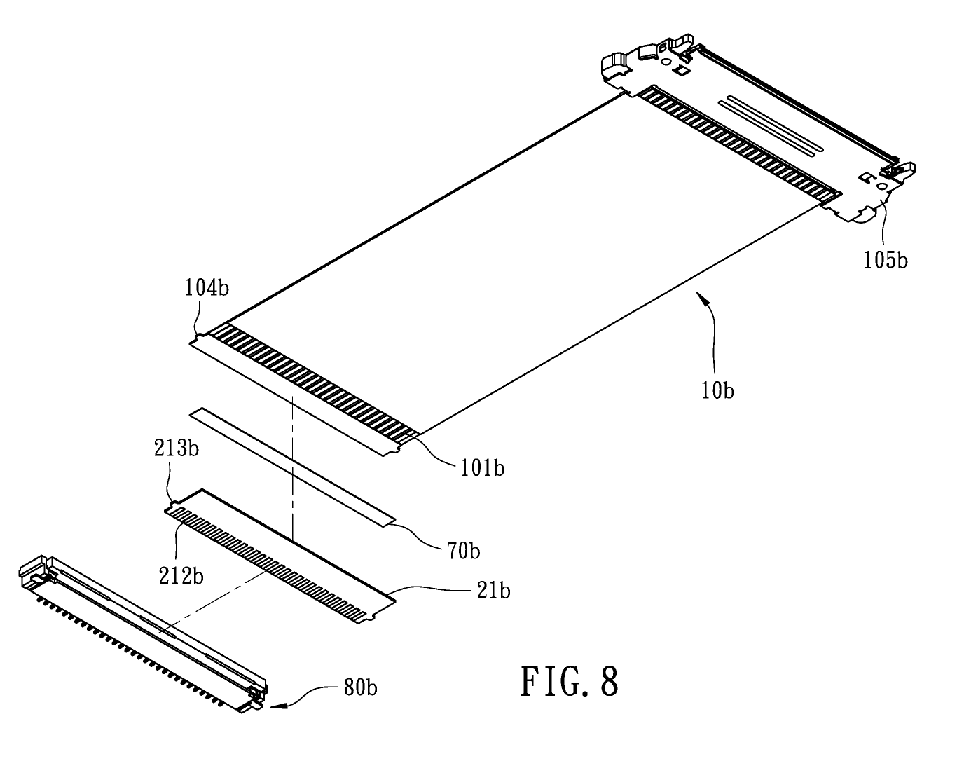

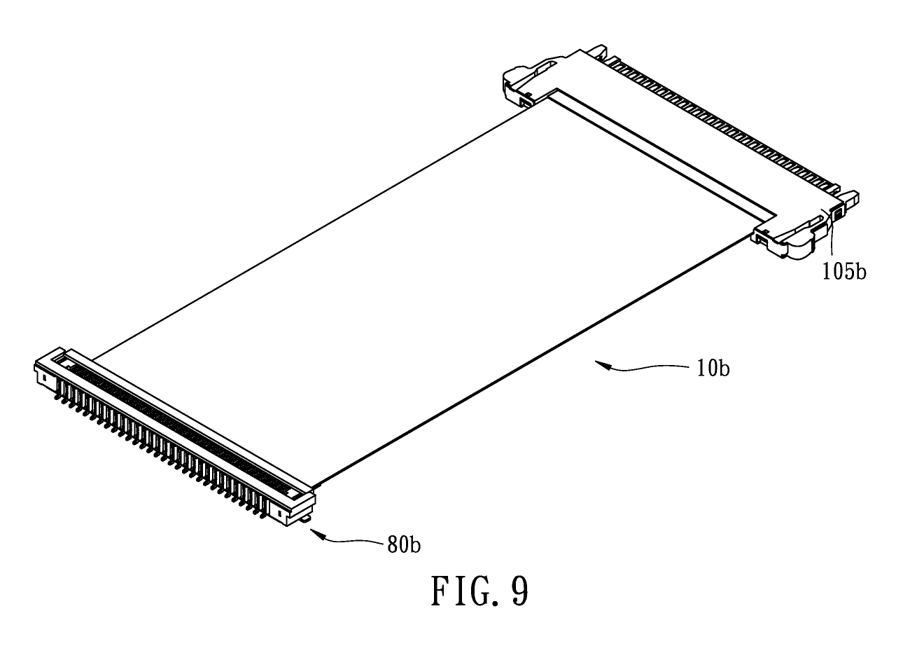

With reference to FIGS. 7-9 that show a third embodiment of a connecting module in accordance with the present invention, in this embodiment, the connecting module includes a flat cable (10b), a circuit board (21b) electrically connected to the flat cable (10b). In addition, the flat cable (10b) and the circuit board (21b) are connected to a connector (80b) after being connected to each other.

The flat cable (10b) has an electric conductive section (101b) formed on a first end thereof. The first end of the flat cable (10b) has two opposite sides each having a protrusion (104b) laterally extending therefrom. An accessory insert board (105b) is electrically connected to a second end of the flat cable (10b). In the preferred embodiment of the present invention, the accessory insert board (105b) is provided for low-voltage differential signaling (LVDS).

A circuit board (21b) is electrically connected to the first end of the flat cable (10b). In the preferred embodiment of the present invention, the circuit board (21b) is a flexible printed circuit (FPC). The circuit board (21b) has a length shorter than that of the flat cable (10b) for saving manufacturing cost. The circuit board (21b) has a first conductive section (211b) and a second conductive section (212b) respectively disposed on two opposite sides thereof, wherein the first conductive section (211b) is electrically connected to the electric conductive section (101b) of the flat cable (10b). In addition, the first conductive section (211b) and the second conductive section (212b) are electrically connected to each other via a displacement circuit (not shown) that is disposed in the circuit board (21b). The circuit board (21b) has two opposite ends respectively having a protrusion (213b) laterally extending therefrom. When assembling the flat cable (10b) and the circuit board (21b) to the connector (80b), each protrusion (213b) of the circuit board (21b) abuts a corresponding one of the two protrusions (104b) of the flat cable (10b) and is inserted into the connector (80b) such that the protrusions (104b, 213b) are engaged to the connector (80b) for connecting the flat cable (10b) and the circuit board (21b) to the connector (80b). Furthermore, an adhering layer (70b) is previously sandwiched between the flat cable (10b) and the circuit board (21b) for easily connected the flat cable (10b) and the circuit board (21b) to the connector (80b). As a result, the second conductive section (212b) is provided to connect with an extra electric interface.

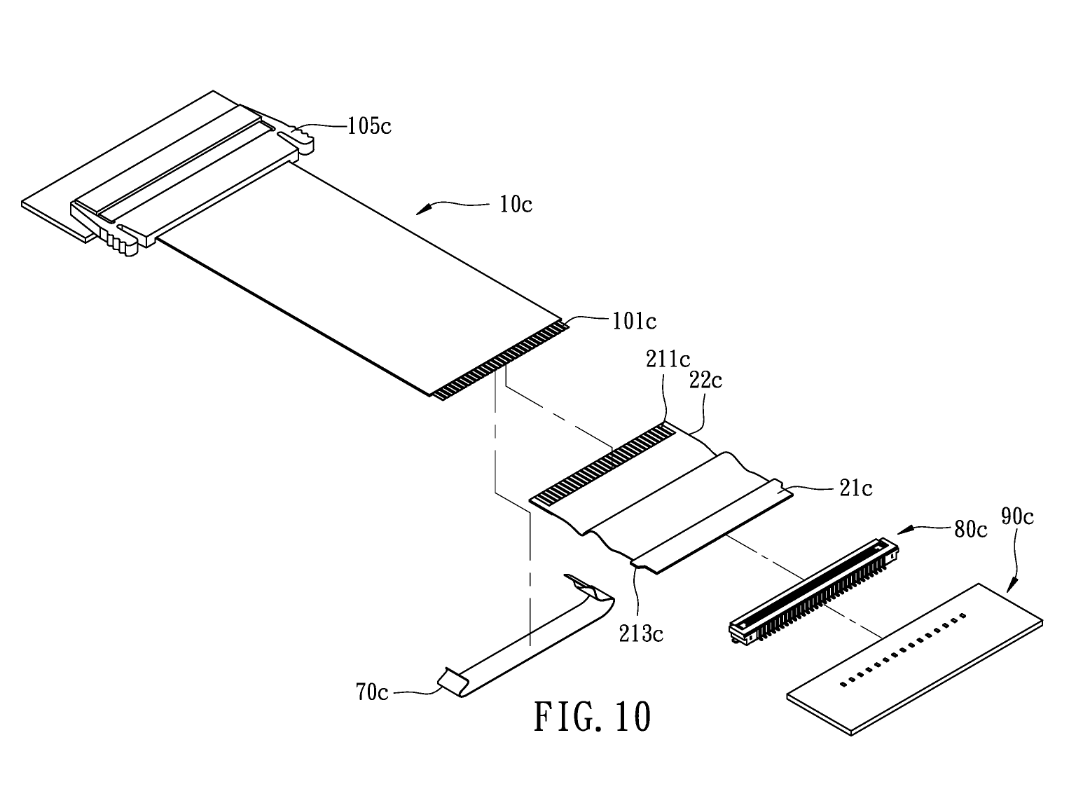

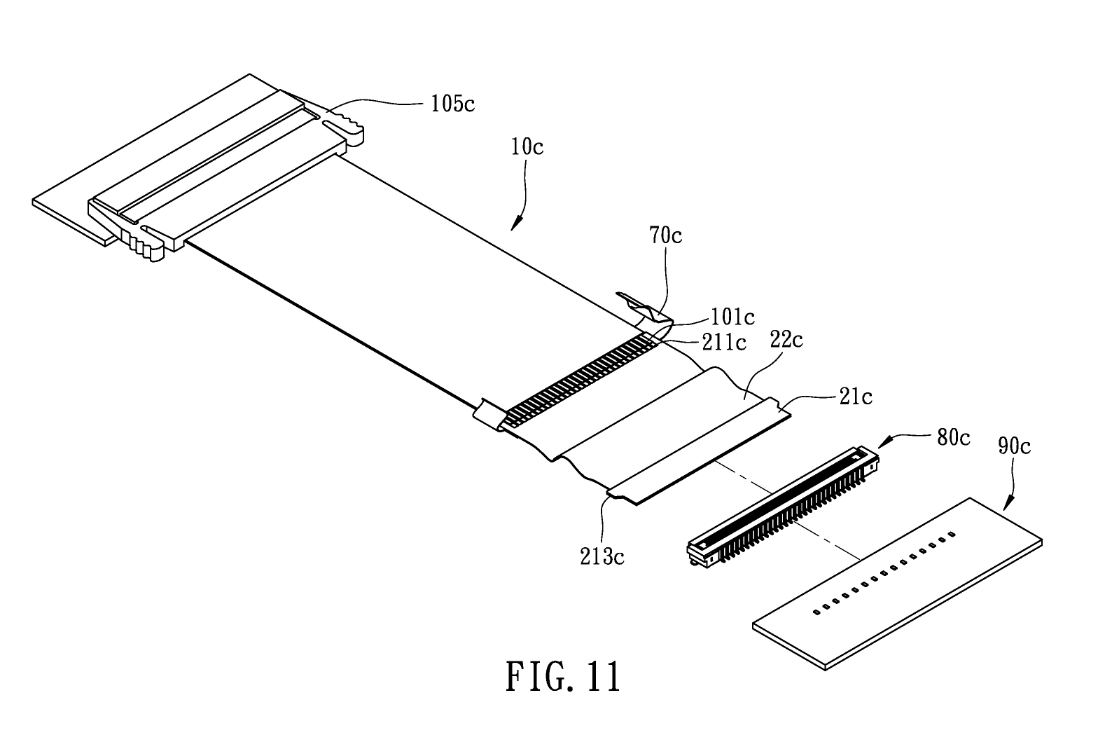

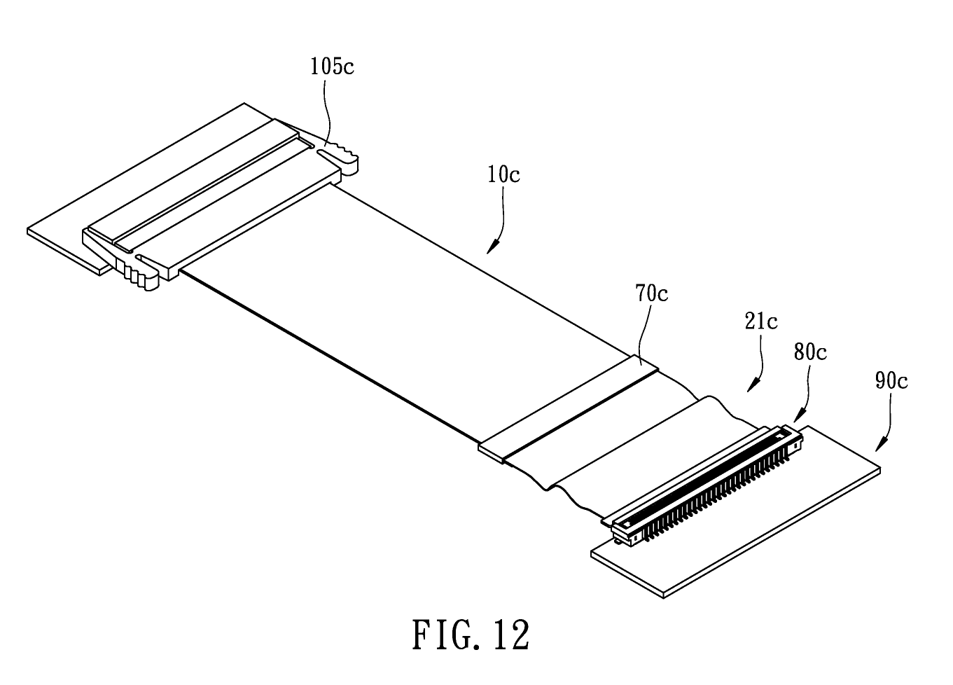

With reference to FIGS. 10-12 that show a fourth embodiment of the connecting module in accordance with the present invention, the fourth embodiment of the present invention has a structure similar to that of the third embodiment, however, the fourth embodiment further includes a system board interface (90c) electrically connected to the connector (80c). The connecting module includes a flat cable (10c) having an accessory insert board (105c) electrically connected to a first end thereof and an electric conductive section (101c) formed on a second end of the flat cable (10c). A circuit board (21c) is electrically connected to the electric conductive section (101c). The circuit board (21c) is formed with an extension portion (22c) having two opposite sides respectively formed with a first conductive section (211c) and a second conductive section (not shown). The first conductive section (211c) is electrically connected to the second conductive section via a displacement circuit that is disposed in the circuit board (21c). The circuit board (21c) has two opposite sides each having a protrusion (213c) laterally extending therefrom. The first conductive section (211c) is electrically connected to the electrically conductive section (101c). An adhering layer (70c) is provided to enclose the first conductive section (211c) and the electric conductive section (101c). The adhering layer (70c) is made of insulating resin for providing an insulation function to the first conductive section (211c) and the electric conductive section (101c). A connector (80c) is connected to the circuit board (21c) by using the two protrusions (213c) and a system board interface (90c) is electrically connected to the connector (80c) for processing the signals from the electric interface that is electrically connected to the accessory insert board (105c).

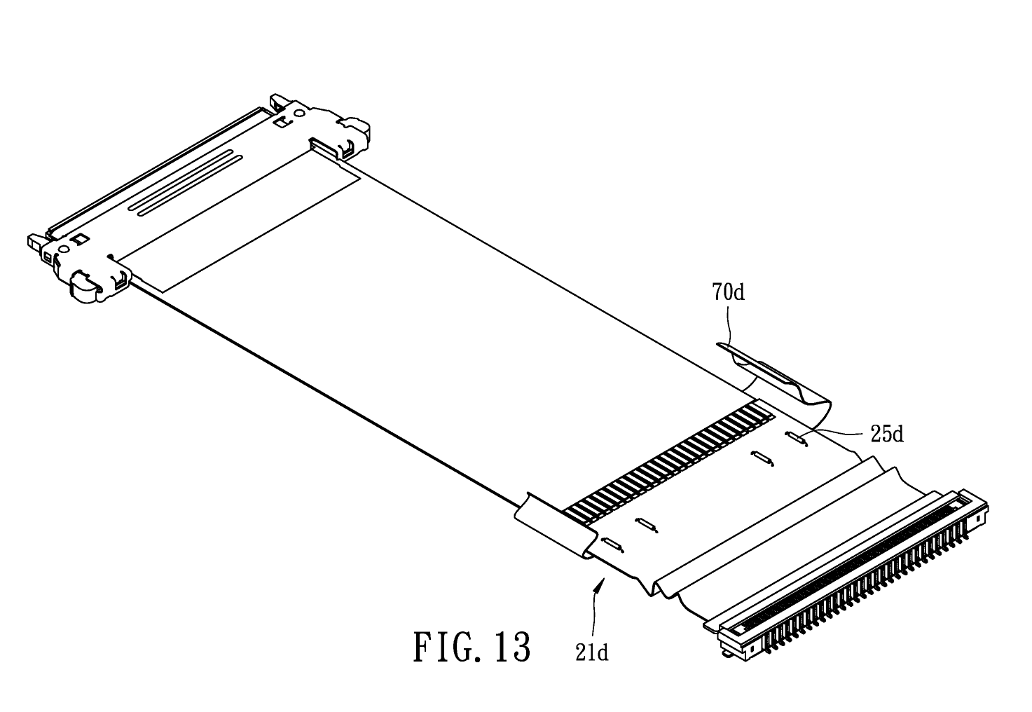

With reference to FIG. 13 that show a fifth embodiment of the connecting module in accordance with the present invention, in this embodiment, the circuit board (21d) has multiple electric elements (25d) electrically mounted thereon. In the preferred embodiment of the present invention, the electric elements (25d) are resistances and/or capacitances for resisting electromagnetic interference during transmitting signals. These electric elements (25d) are exposed or covered by the adhering layer (70d).

Although the invention has been explained in relation to its preferred embodiment, it is to be understood that many other possible modifications and variations can be made without departing from the spirit and scope of the invention as hereinafter claimed.

What is claimed is:

1. A connecting module comprising:
a flat cable comprising a plurality of wires disposed therein and being laterally parallel to one another, each wire having a initial bared end disposed on a initial end and a terminal bared end disposed on a terminal end thereof;
a circuit board electrically connected to the flat cable, the circuit board comprising a first conductive section and a second conductive section respectively disposed thereon, the first conductive section electrically connected to the initial bared end of each of the plurality of wires, the first conductive section and the second conductive section electrically connected to each other via a displacement circuit that is disposed in the circuit board such that correspondences between the first conductive section and the second conductive section are displaced for providing a function as jumper(s); and
an insulator enclosing the circuit board, the insulator formed with a positioning portion for connecting with the circuit board, wherein the second conductive section extends through the positioning portion and is adapted to be connected to an extra electric interface.

2. The connecting module as claimed in claim 1, further comprising:
a connector comprising a plurality of pins adapted to be connected to a system board interface, wherein the plurality of pins of the connector are electrically connected to the terminal bared ends of the plurality of wires.

3. The connecting module as claimed in claim 1, further comprising:
a positioning plate attached to the insulator for holding the circuit board in place;
two fastener respectively mounted to two opposite ends of the insulator for holding the insulator in place when the second conductive section is electrically connected to the extra electric interface; and
a housing mounted on the insulator for protecting the insulator with the circuit board.

4. The connecting module as claimed in claim 1, further comprising a loop enclosing the circuit board with the plurality of initial bared ends and the first conductive section for providing and insulating effect and enhancing the connection between the plurality of initial bared ends and the first conductive section.

5. The connecting module as claimed in claim 1, wherein the insulator is formed with a flat portion and the positioning portion situated on a distal side of the flat portion.

6. The connecting module as claimed in claim 3, wherein the housing includes an upper shell and a lower shell abutting each other for defining a receiving space that is provided to receive the insulator with the positioning plate and the circuit board.

7. The connecting module as claimed in claim 1, wherein the circuit board is a printed circuit board (PCB).

8. The connecting module as claimed in claim 1, wherein the circuit board is a flexible printed circuit (FPC).

9. The connecting module as claimed in claim 1, wherein the first conductive section and the second conductive section are disposed on the same side of the circuit board.

10. The connecting module as claimed in claim 1, wherein the first conductive section and the second conductive section are respectively disposed on two opposite sides of the circuit board.

11. The connecting module as claimed in claim 1, further comprising:
a plate attached to the flat cable near the initial bared end for enhancing the structure of the flat cable; and
a position plate formed on the circuit board corresponding to the plate.

12. The connecting module as claimed in claim 1, wherein the flat cable has two opposite sides each having a protrusion laterally extending therefrom and the circuit board has two opposite ends respectively having a protrusion laterally extending therefrom, each protrusion of the circuit board abutting a corresponding one of the two protrusions of the flat cable for easily connecting the flat cable and the circuit board to the insulator.

13. The connecting module as claimed in claim 1, further comprising an adhering layer previously sandwiched between the flat cable and the circuit board for easily connecting the flat cable and the circuit board to the insulator.

14. The connecting module as claimed in claim 1, wherein the circuit board comprises at least an electric element electrically mounted thereon for resisting an electromagnetic interference during transmitting signals.

15. A connecting module comprising:
a flat cable having an initial electric conductive section formed on a initial end and a terminal electric conductive section formed on a terminal end thereof, a circuit board electrically connected to the flat cable, the circuit board comprising a first conductive section and a second conductive section respectively formed thereon, the first conductive section electrically connected to the initial electric conductive section of the flat cable, the first conductive section and the second conductive section electrically connected to each other via a displacement circuit that is disposed in the circuit board such that correspondences between the first conductive section and the second conductive section are displaced for providing a function as jumper(s);
a first connector electrically connected to the flat cable, wherein a plurality of pins of the first connector is connected to terminal electric conductive section of the flat cable; and
a second connector electrically connected to the circuit board, wherein a plurality of pins of the second connector is connected to the second conductive section of the circuit board.

16. The connecting module as claimed in claim 15, further comprising a system board interface electrically connected to the plurality of pins of the second connector.

17. The connecting module as claimed in claim 15, further comprising a system board interface electrically connected to the plurality of pins of the first connector.

18. The connecting module as claimed in claim 15, wherein the flat cable has two opposite sides each having a protrusion laterally extending therefrom and the circuit board has two opposite ends respectively having a protrusion laterally extending therefrom, each protrusion of the circuit board abutting a corresponding one of the two protrusions of the flat cable and inserted into the second connector such that the protrusions of the flat cable and the circuit board are engaged to the second connector for connecting the flat cable and the circuit board to the second connector.

19. The connecting module as claimed in claim 15, further comprising an adhering layer previously sandwiched between the flat cable and the circuit board for easily connected the flat cable and the circuit board to the second connector.

20. The connecting module as claimed in claim 15, wherein the circuit board comprises at least an electric element electrically mounted thereon for resisting an electromagnetic interference during transmitting signals.
